(19) United States
(12) Patent Application Publication
(10) Pub. No.: US 2023/0136724 A1
(43) Pub. Date: May 4, 2023

(54) SYSTEM & METHOD FOR MANAGING SEGREGATION OF DUTY IN INFORMATION TECHNOLOGY ACCESS MANAGEMENT

(71) Applicant: Saudi Arabian Oil Company, Dhahran (SA)

(72) Inventors: Ahmad F. Sirhani, Dammam (SA); Hussain A. Hajjaj, Saihat (SA); Asma A. Muhaisin, Khobar (SA)

(21) Appl. No.: 17/453,445

(22) Filed: Nov. 3, 2021

(51) Int. Cl. G06F 21/60; G06Q 10/06

(52) U.S. Cl. CPC G06F 21/604; G06Q 10/06375; G06F 2221/2101; G06F 2221/2141

(57) ABSTRACT

A computer-implemented method for managing, in a production environment of an enterprise, a change to a segregation of duties access risk function. At least one computing device accesses information representing a proposed change to an access risk function, and processes the information to determine a related access risk function. The computing device(s) access information associated with the related access risk function and, using the information associated with the proposed change and the information associated with the related access risk function, evaluate respective details in the proposed change. The computing device(s) generate and transmit a message that includes information representing details of the proposed change.

### FIELD OF THE DISCLOSURE

This patent application relates, generally, to systems and methods for data security and, more particularly, to managing changes in information technology access management.

### BACKGROUND OF THE DISCLOSURE

Effective data access risk management is a critical component of securing computer access to confidential, classified, and sensitive objects. In order to maintain security, enterprise-wide access risk management include access control policies to ensure that objects are secure from incidents of fraud or accident. As used herein, objects, generally, can refer to computing resources, such as applications, computing devices and components, on-line services, databases, files, or the like. Access risk management can include segregation of duties (“SOD”) rules and permissions to control access to objects. Generally, SOD policies include access controls that prevent conflicting responsibilities from being performed by one person or group.

Referred to herein, generally, as “access risk functions,” an organization's access risk management policies, rules, and permissions are conventionally developed by parties having an understanding of current business-driven activities and requirements. Effective access risk management, however, often also requires other parties, such as information security analysts and enterprise management personnel, to review and approve changes. Such review and approval is also needed to mitigate the risk of fraud or accident to objects.

Unfortunately, implementing changes in access risk management including SOD can face institutional challenges, including with respect to time and cost. Demand for urgent changes in access risk functions can jeopardize a sufficient review or approval process prior to the access risk functions being implemented in production. Alternatively, despite urgent and critical access risk concerns, implementing a change of an access risk function may be delayed for various reasons. Proposed changes in access risk functionality that are made in development environments may occur periodically (e.g., weekly), which can result in delays in implementation of urgently needed revisions. Further conventional systems may require a technical infrastructure before such changes can formally implemented in production. This can require additional infrastructure and steps prior to implementing a new or changed access risk function. Further, an enterprise's development environment can lack sufficient data to evaluate a new or changed access risk function sufficiently. This, too, can impact the amount of time to implement a changed access risk function.

Referring to FIG. 1, a conventional process is shown in which an access risk function or rule is added, edited, or deleted. Thereafter, a transport file is created and an object is assigned to such function or rule. Thereafter, a transport request is created and imported to a quality control system for approval. If approved, the change is imported into a production environment. Alternatively, the process loops back to assigning an object to the function or rule.

Thus, processes for implementing new or changes in access risk functions in conventionally may carry a long lifecycle, including due to lengthy written detailed descriptions of changes that need to be shared with reviewers and approvers.

It is with respect to this background that the present disclosure is addressed.

### SUMMARY OF THE DISCLOSURE

According to one or more implementations that are consistent with the present disclosure, a computer-based system and method can be provided for managing, in a production environment of an enterprise, a change to a segregation of duties access risk function. In one or more implementations, at least one computing device can be configured by executing instructions for accessing information representing a proposed change to an access risk function. The at least one computing device can further be configured for processing the information associated with the proposed change to determine a related access risk function. Moreover, the at least one computing device can be configured for accessing information associated with the related access risk function. Thereafter, the at least one computing device can be configured for evaluating, using the information associated with the proposed change and the information associated with the related access risk function, respective details in the proposed change. The at least one computing device can be configured for generating a message that includes information representing the respective details in the proposed change, and for transmitting to at least one other computing device in the production environment, the message. Thereafter, the at least one computing device can be configured for receiving approval to implement the proposed change. The proposed change to the access risk function is implemented in the production environment as a function of the received approval. Moreover, the at least one computing device can be configured for generating an audit trail representing the change to the access risk function.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawing figures illustrate exemplary embodiments and are not intended to be limiting of the present disclosure. Among the drawing figures, like references are intended to refer to like or corresponding parts.

FIG. 1 illustrates a conventional process in which an access risk function or rule is added/edited/or deleted;

FIG. 2 is a diagram is provided that illustrates an use case 200 involving computing devices operated by stakeholders in an enterprise, in accordance with an example implementation of the present disclosure.

FIG. 3 is a flow diagram is described showing an example routine 300 that illustrates a broad aspect of a method for implementing a change in access risk functionality, in accordance with one or more embodiments of the present disclosure.

FIG. 4 illustrates an example message that is generated in accordance with the present disclosure that identifies an updated access risk function, which can be transmitted by an information processor to one or more computing devices.

FIG. 5 is a block diagram that shows an example hardware arrangement that operates for providing the systems and methods disclosed herein.

FIG. 6 shows an example of an information processor that can be used to implement the techniques described herein the present disclosure.

### DETAILED DESCRIPTION OF CERTAIN EMBODIMENTS ACCORDING TO THE DISCLOSURE

The disclosure and the various features and advantageous details thereof are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques can be omitted so as to not unnecessarily obscure the embodiments of the disclosure. The examples used are intended merely to facilitate an understanding of ways in which the disclosure may be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

By way of overview and introduction, the present disclosure presents technical methods and systems for managing additions, modifications, and removals of information technology access risk functionality. Access risk functionality can include, for example, rules and permissions that assign functions associated with at least one process to more than one person or department (e.g., SOD).

The methods and systems disclosed herein can include computing devices that are configured by executing instructions to implement access risk management directly in a production environment of an enterprise, as opposed to operating, for example, within a separate development environment. Moreover, such devices can be configured to interface with other devices operated by personnel associated with an organization (e.g., an enterprise), such as information security analysts and management personnel. Features shown and described herein facilitate prompt review and approval of changes by such personnel in advance of such changes in access risk management being executed in production. The present disclosure significantly reduces the lifecycle typically required for creating or modifying existing access risk functions, and enables urgently need changes to be implemented rapidly and accurately.

In one or more implementations of the present disclosure, a computing device is configured to detect automatically changes in an enterprise's access risk function, such as policy additions, modifications, and removals. For example, an enterprise's business analyst operates a computing device to submit a change, such as an addition, deletion, or modification of an access risk function. Thereafter, information associated with the change can be detected automatically by one or more devices which, thereafter, access information representing a current access risk function that is in place (provided one exists). The information can be used to generate a comparison and/or information associated with the proposed change, which can then be transmitted to device(s) operated by appropriate enterprise personnel for review and approval of the change.

The present disclosure provides technical improvements over conventional systems in which access management rules or permissions are initially assigned to objects outside of a production environment (e.g., in a development environment). The present disclosure results in proposed access risk function changes being received instantaneously, and messages, which identify the proposed change and information setting forth particulars associated with the change, are generated and transmitted to one or more computing devices to enable informed review and approval by appropriate personnel.

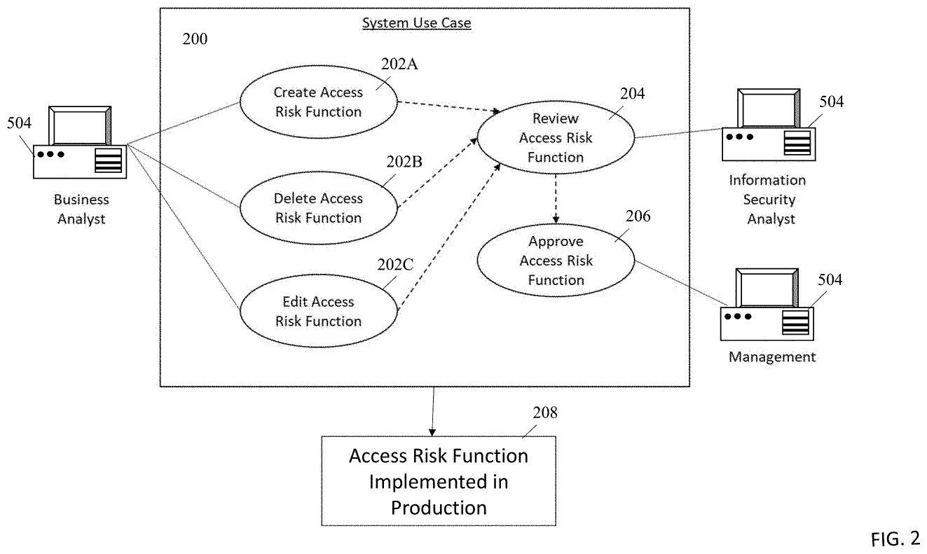

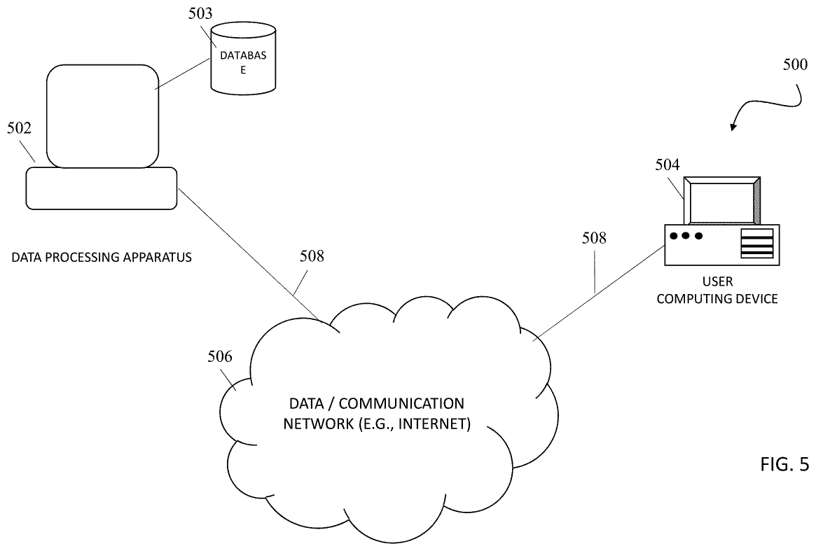

Turning now to FIG. 2, a diagram is provided that illustrates an use case 200 involving computing devices operated by stakeholders in an enterprise, in accordance with an example implementation. Information associated with a change in access risk management is received, for example, by an information processor (not shown), and processed to provide features shown and described herein. As shown in FIG. 2, an authorized business analyst associated with a respective organization proposes a change to an access risk function via computing device 504 (FIG. 5), such as to create an access risk function 202A, delete an access risk function 202B, and/or edit an access risk function 202C. For example, changes are developed and proposed within a governance, risk, and compliance (“GRC”) application operating in a production environment, to detect and/or prevent SOD conflicts associated with access to one or more objects by one or more employees/users. In one or more implementations, the business analyst can identify SOD conflicts in response to data processing, such as via analytical reports or substantially in real time during the provisioning or de-provisioning of applications.

Continuing with reference to FIG. 2, information associated with the proposed access risk function can be reviewed (204) and approved (206) by appropriate personnel. For example, an information security analyst reviews the proposed access risk function, and management personnel operate on a recommendation made by the information security analyst to approve the access risk function. Thereafter, the access risk function is implemented in production (208).

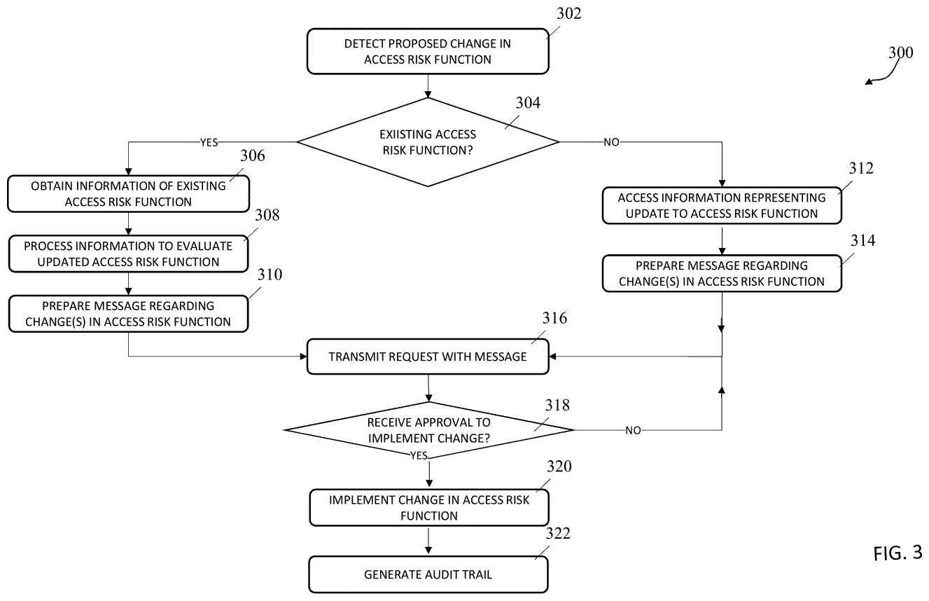

FIG. 3 is a flow diagram is described showing an example routine 300 that illustrates a broad aspect of a method for implementing a change in access risk functionality, in accordance with one or more embodiments of the present disclosure. It is to be appreciated that several of the logical operations shown and described herein are implemented as a sequence of computer-implemented acts or program modules running on one or more computing devices. Accordingly, the logical operations described herein are referred to variously as operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Continuing with reference to FIG. 3, the process begins at step 302 in which an information processor 502 (FIG. 5) detects a proposed change in an access risk function. For example, a change is proposed to account for a SOD conflict. Thereafter, at step 304 a determination is made whether a related existing access risk management function exists. If so, then the process branches to step 306 and information associated with the existing access risk function is obtained. The obtained information is processed to evaluate the updated access risk function, including to represent particular changes being made to the existing access risk function (step 308). Thereafter, at step 310 a message is prepared regarding the change(s) in the access risk function.

Alternatively, if the determination at step 304 is that there is no related existing risk management function, then the process branches to step 312 and information representing the update (e.g., the addition or removal of the access risk function). At step 314, a message is prepared regarding the change(s) in the access risk function.

At step 316, a request with the prepared message from step 310 or 314 is transmitted, for example, to a computing device 504 operated by authorized personnel of the enterprise. Thereafter, a determination is made at step 318 whether approval to implement the change in the access risk function has been received. If not, then the process branches back to step 316 and the request is resent. The resent request may include the message generated at step 310 or 314. Alternatively, if the determination at step 318 is that approval has been received, for example, by a computing device operated by management in the enterprise, then the process branches to step 320 and the change to the access risk function is implemented in production. Moreover, at step 322, an audit trail is generated, for example, by making an entry in a log or other data resource representing the process and/or the change to the respective access risk function.

Thus, as shown and described above with reference to FIG. 3, a process is provided for managing changes in an access risk function directly within a production environment. The present disclosure provides a reviewer (e.g., an information security analyst) and approver (e.g., management) with detailed and clear information representing changes in access risk functionality, including by comparing previous changes that were made to a specific access risk function. Changes are ensured of being properly reviewed and approved before being implemented in production, and corresponding details, including details of a request, an identification of the party making the request, changes to the access risk function, or the like, and are logged for future reference, such as in an audit trail.

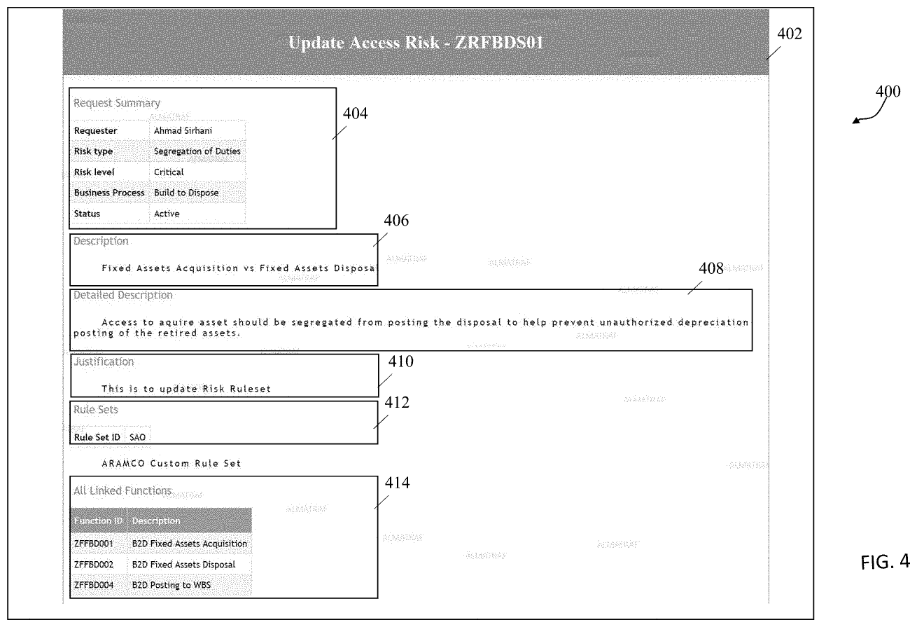

FIG. 4 illustrates an example message 400 that is generated in accordance with the present disclosure that identifies an updated access risk function 402, which can be transmitted by an information processor 502 (FIG. 5) to one or more computing devices 504. In one or more implementations, a message can link or define new conditions to capture SoD. In request summary section 404, information is provided that identifies the requester of the change, the type of risk (e.g., need for SOD), a designated risk level (e.g., mild, moderate, or critical). Further, information representing a business process (“Build to Dispose”) and status (“active”) are provided. A Build to Dispose process can include supplying material uses for material lifecycle. Additional data options (not shown) can refer to status of a function that is set to inactive, which places a hold on further changes hold until reviewed and approved by appropriate personnel. Certain functions can be defined for SoD, such as any party who procures certain material cannot, thereafter, also dispose of the material.

Continuing with reference to the example message 400 shown in FIG. 4, description section 406 identifies a brief amount information associated with the requested updated access risk function, and detailed description section 408 identifies more particulars regarding the access risk function, such as SOD to prevent unauthorized depreciating of a retired asset. Further, justification section 410 identifies reasons for the request (e.g., to “update Risk Ruleset”) and corresponding rules sets section 412. Moreover, linked functions section 414 identifies respective function identifiers and descriptions that relate to the requested updated access risk function.

Thus, and as shown in FIG. 4, example message 400 can be generated and provided for a reviewer. Following reception of approval therefor, a workflow is updated once the access risk function is created or modified. It is to be appreciated that the present disclosure is adaptive to many (if not all) organizations employing information technology access management, including via a governance system that uses functions and permissions to control segregation of duty. Unlike conventional systems, the present disclosure provides a rapid resolution once a critical access risk is identified and requires an immediate implementation, such as SOD, by creating, modifying, or removing an existed access risk function. Further, proper review and approval of such change is ensured as a function of the technical features shown and described herein, and audit trails are provided for future analysis, including in case additional changes to a respective access risk function are requested.

Moreover, the present disclosure provides a system that can operate to check an access risk function status and its relationship to lower level rights actions, such as permissions or activities. A function can have one or more attributes, such as risk type, risk level, business process, and status. Once an attribute is changed, such as to deactivate the function or to alter the business process, a trigger can occur. Moreover, the conditions can include lower level actions or each function that is mapped with each other by AND or OR to determine if end user should have those permission or not. Once those conditions are added, updated, or deleted a trigger can also be made.

When predefined conditions are met, a request can be sent with a detailed message for an access risk proponent to review and approve the creation or modification of the request. The function can include a combination of functions or can include a set of conditions of actions, such as release payment or initiate procurement request. These kinds of activities/actions can part of a function to determine whether to be assigned to an end user to ensure proper segregation of duty. The conditions for the request to be initiated can include whether the whole function status is changed or if the linkage of the list of actions within the function is added, updated, or deleted. The features shown and described herein ensure improved efficiency, that changes are reliable, and that audit logs of changes are captured in order to mitigate or eliminate any protentional risk/fraud.

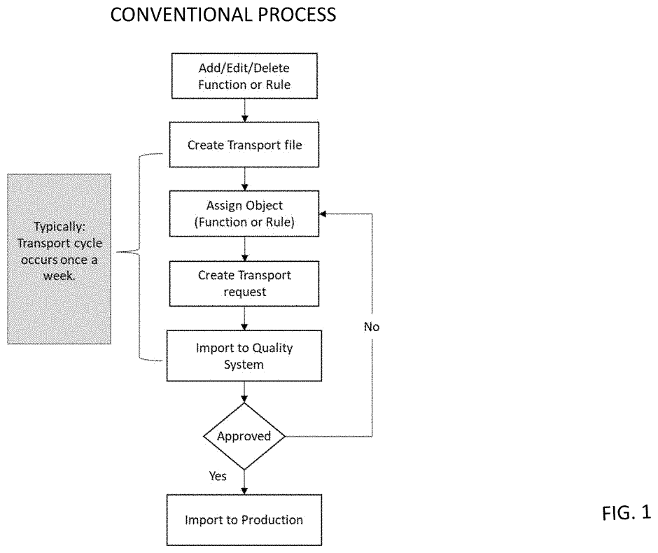

The technical solution provided herein provides a new approach to managing processes in a production environment by configuring systems and methods to operate with the workflow engine that manages the creation, modification, or deletion of the access risk functionality. The solutions replaces the lengthy transport mechanism (FIG. 1) and improves security within access risk management.

Referring to FIG. 5, a diagram is provided that shows an example hardware arrangement that operates for providing the systems and methods disclosed herein, and designated generally as system 500. System 500 can include one or more information processors 502 that are at least communicatively coupled to one or more user computing devices 504 across communication network 506. Information processors 502 and user computing devices 504 can include, for example, mobile computing devices such as tablet computing devices, smartphones, personal digital assistants or the like, as well as laptop computers and/or desktop computers, server computers and mainframe computers. Further, one computing device may be configured as an information processor 502 and a user computing device 504, depending upon operations being executed at a particular time.

With continued reference to FIG. 5, information processor 502 can be configured to access one or more databases 503 for the present disclosure, including source code repositories and other information. However, it is contemplated that information processor 502 can access any required databases via communication network 506 or any other communication network to which information processor 502 has access. Information processor 502 can communicate with devices comprising databases using any known communication method, including a direct serial, parallel, universal serial bus (“USB”) interface, or via a local or wide area network.

User computing devices 504 can communicate with information processors 502 using data connections 508, which are respectively coupled to communication network 506. Communication network 506 can be any communication network, but typically is or includes the Internet or other computer network. Data connections 508 can be any known arrangement for accessing communication network 506, such as the public internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 504 preferably have the ability to send and receive data across communication network 506, and are equipped with web browsers, software applications, or other means, to provide received data on display devices incorporated therewith. By way of example, user computing device 504 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 506, and that wireless communication can be provided between wireless devices and information processors 502.

System 500 preferably includes software that provides functionality described in greater detail herein, and preferably resides on one or more information processors 502 and/or user computing devices 504. One of the functions performed by information processor 502 is that of operating as a web server and/or a web site host. Information processors 502 typically communicate with communication network 506 across a permanent i.e., un-switched data connection 508. Permanent connectivity ensures that access to information processors 502 is always available.

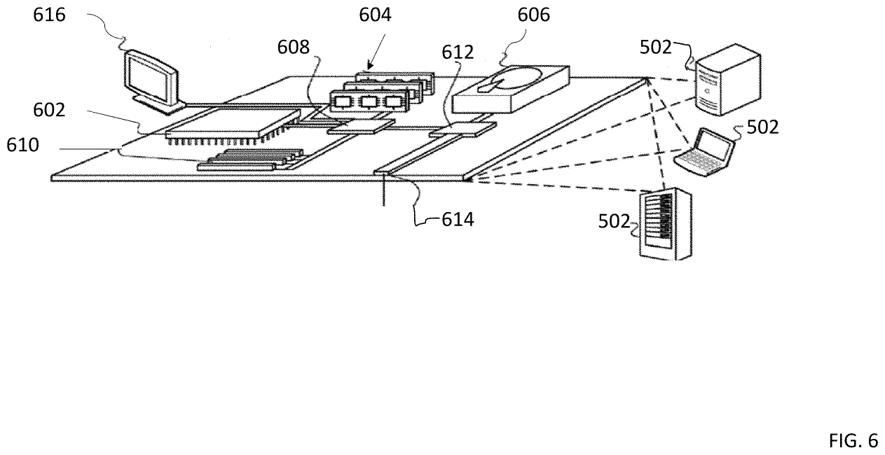

FIG. 6 shows an example information processor 502 that can be used to implement the techniques described herein. The information processor 502 is intended to represent various forms of digital computers, such as laptops, desktops, workstations, personal digital assistants, servers, blade servers, mainframes, and other appropriate computers. The components shown in FIG. 6, including connections and relationships, and their functions, are meant to be exemplary only, and are not meant to limit implementations of the inventions described and/or claimed in this document.

The information processor 502 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and can be mounted on a common motherboard or in other manners as appropriate. The processor 602 can process instructions for execution within the information processor 502, including instructions stored in the memory 604 or on the storage device 606 to display graphical information for a GUI on an external input/output device, such as a display 616 coupled to the high-speed interface 608. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 604 stores information within the information processor 502. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the information processor 502. In some implementations, the storage device 606 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 can be configured to manage bandwidth-intensive operations, while the low-speed interface 612 can be configured to manage lower bandwidth-intensive operations. Of course, one of ordinary skill in the art will recognize that such allocation of functions is exemplary only. In some implementations, the high-speed interface 608 is coupled to the memory 604, the display 616 (e.g., through a graphics processor or accelerator), and to the high-speed expansion ports 610, which can accept various expansion cards (not shown). In an implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

As noted herein, the information processor 502 can be implemented in a number of different forms, as shown in the figure. For example, it can be implemented as a standard server, or multiple times in a group of such servers. In addition, it can be implemented in a personal computer such as a laptop computer. It can also be implemented as part of a rack server system. Alternatively, components from the computing device 200 can be combined with other components in a mobile device (not shown), such as a mobile computing device.

The terms “a,” “an,” and “the,” as used in this disclosure, means “one or more,” unless expressly specified otherwise.

The term “communicating device,” as used in this disclosure, means any hardware, firmware, or software that can transmit or receive data packets, instruction signals or data signals over a communication link. The hardware, firmware, or software can include, for example, a telephone, a smart phone, a personal data assistant (PDA), a smart watch, a tablet, a computer, a software defined radio (SDR), or the like, without limitation.

The term “communication link,” as used in this disclosure, means a wired and/or wireless medium that conveys data or information between at least two points. The wired or wireless medium can include, for example, a metallic conductor link, a radio frequency (RF) communication link, an Infrared (IR) communication link, an optical communication link, or the like, without limitation. The RF communication link can include, for example, Wi-Fi, WiMAX, IEEE 802.11, DECT, 0G, 1G, 2G, 3G or 4G cellular standards, Bluetooth, or the like, without limitation.

The terms “computer” or “computing device,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a server farm, a computer cloud, or the like, or an array of processors, microprocessors, central processing units, general purpose computers, super computers, personal computers, laptop computers, palmtop computers, notebook computers, desktop computers, workstation computers, servers, or the like, without limitation.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, Wi-Fi, WiMAX, IEEE 802.11, DECT, 0G, 1G, 2G, 3G, 4G, or 5G cellular standards, Bluetooth, or the like.

The terms “transmission” and “transmit,” as used in this disclosure, refer to the conveyance of signals via electricity, acoustic waves, light waves and other electromagnetic emissions, such as those generated in connection with communications in the radio frequency (RF) or infrared (IR) spectra. Transmission media for such transmissions can include coaxial cables, copper wire and fiber optics, including the wires that comprise a system bus coupled to the processor.

The term “database,” as used in this disclosure, means any combination of software and/or hardware, including at least one application and/or at least one computer. The database can include a structured collection of records or data organized according to a database model, such as, for example, but not limited to at least one of a relational model, a hierarchical model, a network model or the like. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and variations thereof, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which can be configured to communicate data via a wireless and/or a wired communication medium. These networks can run a variety of protocols not limited to TCP/IP, IRC or HTTP.

The term “server,” as used in this disclosure, means any combination of software and/or hardware, including at least one application and/or at least one computer to perform services for connected clients as part of a client-server architecture. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The invention encompassed by the present disclosure has been described with reference to the accompanying drawings, which form a part hereof, and which show, by way of illustration, example implementations and/or embodiments. As such, the figures and examples above are not meant to limit the scope of the present disclosure to a single implementation, as other implementations are possible by way of interchange of some or all of the described or illustrated elements, without departing from the spirit of the present disclosure. Among other things, for example, the disclosed subject matter can be embodied as methods, devices, components, or systems.

Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Furthermore, it is recognized that terms used herein can have nuanced meanings that are suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter can be based upon combinations of individual example embodiments, or combinations of parts of individual example embodiments.

The foregoing description of the specific implementations will so fully reveal the general nature of the disclosure that others can, by applying knowledge within the skill of the relevant art(s) (including the contents of the documents cited and incorporated by reference herein), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown of drawings are shown accordingly to one example and other dimensions can be used without departing from the present disclosure.

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described example implementations, and the invention is to be understood as being defined by the recitations in the claims which follow and structural and functional equivalents of the features and steps in those recitations.

What is claimed:

1. A computer-implemented method for managing, in a production environment of an enterprise, a change to a segregation of duties access risk function, the method comprising:
accessing, by at least one computing device configured by executing instructions, information representing a proposed change to an access risk function;
processing, by the at least one computing device, the information associated with the proposed change to determine a related access risk function;
accessing, by the at least one computing device, information associated with the related access risk function;
evaluating, by the at least one computing device using the information associated with the proposed change and the information associated with the related access risk function, respective details in the proposed change;
generating, by the at least one computing device, a message that includes information representing the respective details in the proposed change;
transmitting, by the at least one computing device to at least one other computing device in the production environment, the message;
receiving, by the at least one computing device, approval to implement the proposed change, wherein the proposed change to the access risk function is implemented in the production environment as a function of the received approval; and
generating, by the at least one computing device, an audit trail representing the change to the access risk function.

2. The method of claim 1, wherein accessing the information representing the proposed change to the access risk function comprises:
detecting, by the at least one computing device, that the proposed change has been submitted by a computing device operated by a business analyst in the production environment.

3. The method of claim 2, wherein the proposed change is submitted via a governance, risk, and compliance application operating in a production environment.

4. The method of claim 1, wherein the approval to implement the proposed change is received from at least one computing device operated by management personnel of the enterprise in the production environment.

5. The method of claim 1, wherein transmitting the message by the at least one computing device includes:
transmitting, by the at least one computing device, the message to at least one device associated with a governance, risk, and compliance application operating in the production environment.

6. The method of claim 1, wherein the lifecycle of the proposed change is reduced as a function of receiving the approval.

7. A computer-implemented method for managing, in a production environment of an enterprise, a change to a segregation of duties access risk function, the method comprising:
accessing, by at least one computing device configured by executing instructions, information representing a proposed change to an access risk function;
processing, by the at least one computing device, the information associated with the proposed change to determine no related access risk function exists;
evaluating, by the at least one computing device using the information associated with the proposed change, respective details in the proposed change;
generating, by the at least one computing device, a message that includes information representing the respective details in the proposed change;
transmitting, by the at least one computing device to at least one other computing device in the production environment, the message;
receiving, by the at least one computing device, approval to implement the proposed change, wherein the proposed change to the access risk function is implemented in the production environment as a function of the received approval; and
generating, by the at least one computing device, an audit trail representing the change to the access risk function.

8. The method of claim 7, wherein accessing the information representing the proposed change to the access risk function comprises:
detecting, by the at least one computing device, that the proposed change has been submitted by a computing device operated by a business analyst in the production environment.

9. The method of claim 8, wherein the proposed change is submitted via a governance, risk, and compliance application operating in a production environment.

10. The method of claim 7, wherein the approval to implement the proposed change is received from at least one computing device operated by management personnel of the enterprise in the production environment.

11. The method of claim 7, wherein transmitting the message by the at least one computing device includes:
transmitting, by the at least one computing device, the message to at least one device associated with a governance, risk, and compliance application operating in the production environment.

12. The method of claim 7, wherein the lifecycle of the proposed change is reduced as a function of receiving the approval.

13. A computer-implemented system for managing, in a production environment of an enterprise, a change to a segregation of duties access risk function, the system comprising:
at least one computing device, wherein the at least one computing device is configured by executing instructions for:
accessing, by at least one computing device configured by executing instructions, information representing a proposed change to an access risk function;
processing, by the at least one computing device, the information associated with the proposed change to determine a related access risk function;
accessing, by the at least one computing device, information associated with the related access risk function;
evaluating, by the at least one computing device using the information associated with the proposed change and the information associated with the related access risk function, respective details in the proposed change;
generating, by the at least one computing device, a message that includes information representing the respective details in the proposed change;
transmitting, by the at least one computing device to at least one other computing device in the production environment, the message;
receiving, by the at least one computing device, approval to implement the proposed change, wherein the proposed change to the access risk function is implemented in the production environment as a function of the received approval; and
generating, by the at least one computing device, an audit trail representing the change to the access risk function.

14. The system of claim 13, wherein accessing the information representing the proposed change to the access risk function comprises:
detecting, by the at least one computing device, that the proposed change has been submitted by a computing device operated by a business analyst in the production environment.

15. The system of claim 14, wherein the proposed change is submitted via a governance, risk, and compliance application operating in a production environment.

16. The system of claim 13, wherein the approval to implement the proposed change is received from at least one computing device operated by management personnel of the enterprise in the production environment.

17. The system of claim 13, wherein transmitting the message by the at least one computing device includes:
transmitting, by the at least one computing device, the message to at least one device associated with a governance, risk, and compliance application operating in the production environment.

18. The system of claim 13, wherein the lifecycle of the proposed change is reduced as a function of receiving the approval.
